(19) United States
(12) Patent Application Publication
(10) Pub. No.: US 2004/0142707 A1
(43) Pub. Date: Jul. 22, 2004

(54) Inter-carrier short text message delivery

(76) Inventors: David Midkiff, Kirkland, WA (US); Thomas Cast, Redmond, WA (US)

Correspondence Address: IPSOLON LLP, 805 SW BROADWAY, #2740, PORTLAND, OR, 97205, US

(21) Appl. No.: 10/347,504

(22) Filed: Jan. 17, 2003

(51) Int. Cl. H04Q 7/20

(52) U.S. Cl. 455/466; 455/422.1

(57) ABSTRACT

A method is provided for routing mobile telephone short text messages between different mobile telephone messaging networks, including mobile telephone messaging networks operated by a single carrier (i.e., intra-carrier messaging) or by different carriers (i.e., inter-carrier messaging). The method includes receiving a short text message at a mobile telephone short message gateway operated by a first mobile telephone carrier, the short text message having a destination directory number (DN). The short message gateway determines that the destination directory number (DN) is associated with one of two or more mobile telephone networks. The two or more mobile telephone networks may be operated by the first mobile telephone carrier alone or by the first mobile telephone carrier and another carrier. The short text message is then routed to the appropriate mobile telephone network based upon its destination directory number (DN). In a particular implementation, the short text message is a Short Message Service (SMS) message, and the short message gateway is a Short Message Peer to Peer (SMPP) gateway. The routing of the SMS includes reformatting it to include a Simple Mail Transfer Protocol (SMTP) address of an SMPP gateway of the mobile telephone messaging network to which the SMS message is directed. The SMS message is then sent as an SMTP message over the Internet.

### TECHNICAL FIELD

The present invention relates to delivery of short text messages in a mobile telephone messaging network and, in particular, to routing of short text messages between different mobile telephone messaging networks.

### BACKGROUND AND SUMMARY

Mobile telephone messaging networks commonly provide short text messaging such as, for example, the standard Short Message Service (SMS) that supports transmission of alphanumeric messages between mobile telephone subscribers and other short message devices. By one convention, alphanumeric messages of up to 160 characters can be transmitted. For example, a short message (e.g., “Don't forget to buy milk”) may be sent from a first wireless phone to a second wireless phone and may appear on a display of the second wireless phone.

An industry standard Short Message Peer to Peer (SMPP) messaging protocol simplifies simplify integration of data applications with mobile telephone messaging networks. This protocol was published as “Short Message Peer to Peer Protocol Specification” (version 3.4, Issue 1.2, Oct. 12, 1999) (available at http://www.smpp.org/). SMS messages may be routed between a mobile telephone messaging network and different SMS data applications via an SMPP gateway.

Short text messages within a mobile telephone messaging network are commonly transmitted according to the directory numbers (DN) (i.e., a 10-digit phone number) assigned to mobile telephones and other short message devices. With directory numbers alone, short text messages cannot be transmitted between mobile telephones and other short message devices associated with different mobile telephone messaging networks. As a consequence, short text messaging between subscribers to different mobile telephone messaging networks can be inconvenient or even unworkable.

With the variety of available mobile telephone messaging networks, many people who might wish to send short text messages to each other might subscribe to different mobile telephone messaging networks. Conventional short text messaging would make such communications inconvenient or unworkable.

Accordingly, the present invention provides a method of routing mobile telephone short text messages between different mobile telephone messaging networks, including mobile telephone messaging networks operated by a single carrier (i.e., intra-carrier messaging) or by different carriers (i.e., inter-carrier messaging). The method includes receiving a short text message at a mobile telephone short message gateway operated by a first mobile telephone carrier, the short text message having a destination directory number (DN).

The short message gateway determines that the destination directory number (DN) is associated with one of two or more mobile telephone networks. The two or more mobile telephone networks may be operated by the first mobile telephone carrier alone or by the first mobile telephone carrier and another carrier. The short text message is then routed to the appropriate mobile telephone network based upon its destination directory number (DN).

In a particular implementation, the short text message is a Short Message Service (SMS) message, and the short message gateway is a Short Message Peer to Peer (SMPP) gateway. The routing of the SMS includes reformatting it to include a Simple Mail Transfer Protocol (SMTP) address of an SMPP gateway of the mobile telephone messaging network to which the SMS message is directed. The SMS message is then sent as an SMTP message over the Internet.

The present invention has several advantages over conventional short text messaging. Short text messages can be transmitted conveniently mobile phone messaging networks, even those operated by different carriers. For example, messages can be delivered to subscribers who can receive messages by e-mail with an address of the form DN@domain.com use existing SMTP delivery procedures. Also, messages can be delivered to and from networks with otherwise incompatible messaging technologies, for example GSM, CDMA, etc.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a schematic block diagram of a cellular mobile telephone messaging system to illustrate an operating environment for inter-carrier messaging according to the present invention.

FIG. 2 is a flow diagram of a generalized implementation of an inter-carrier messaging method according to the present invention.

FIGS. 3A-3C are a flow diagram of a gateway routing method.

FIG. 4 is a sequential step diagram illustrating a 2G-3G delivery sequence for delivering a mobile-originated message from a 2G network of an implementing carrier to a 3G network of the same carrier.

FIG. 5 is a sequential step diagram illustrating a 2G/inter-carrier delivery sequence for delivering a mobile-originated message from a 2G network of an implementing carrier to another carrier.

FIG. 6 is a sequential step diagram illustrating a 3G/inter-carrier delivery sequence for delivering a mobile-originated message from a 3G network of an implementing carrier to another carrier.

FIG. 7 is a sequential step diagram illustrating a 2G-MT delivery sequence for delivering a mobile-terminated message to a 2G network.

FIG. 8 is a sequential step diagram illustrating a 3G-MT delivery sequence for delivering a mobile-terminated message to a 3G network.

### DETAILED DESCRIPTION OF PREFERRED EMBODIMENT

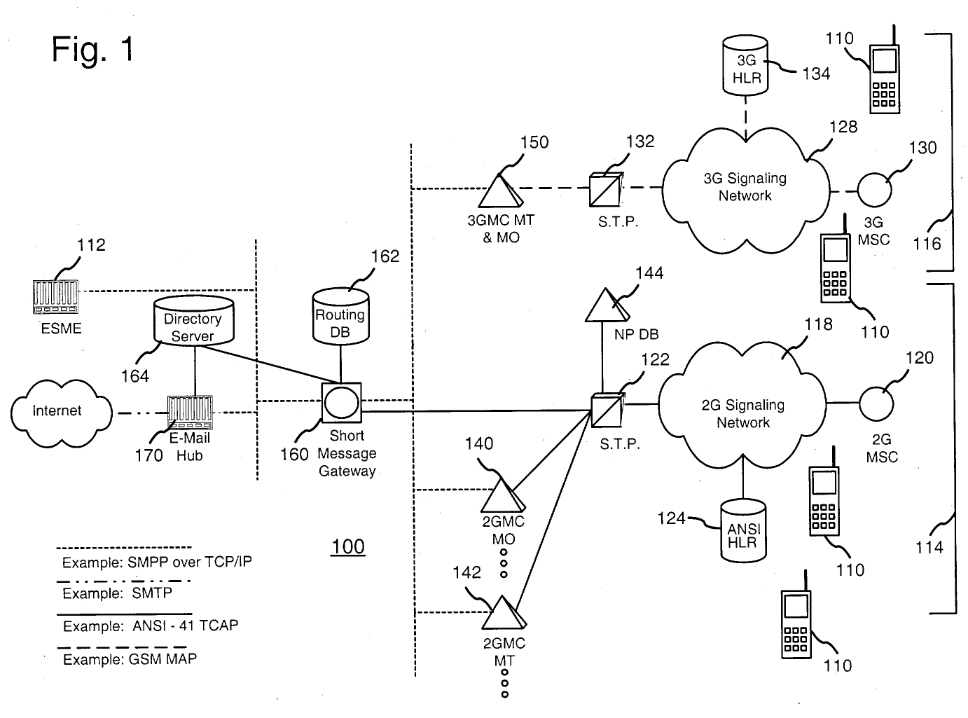

FIG. 1 is a schematic block diagram of a cellular mobile telephone messaging system 100 to illustrate an operating environment for inter-carrier messaging according to the present invention. The inter-carrier messaging transmits short text messages between different mobile telephone networks. In one implementation, the short text messages conform to a Short Message System (SMS) standard format, as are known in the art. It will be appreciated, however, that other mobile telephone short text message formats could be employed.

Short text messages are transmitted from or to cellular mobile telephones 10 as mobile-originated messages (MO) or mobile-terminated messages (MT), respectively. In addition to being transmitted to or from mobile telephones 10, the short text messages can also be transmitted to or from any other external short messaging entity (ESME) 112 (only one shown). External short messaging entity (ESME) 112 may encompass any of a variety of electronic communication formats or systems, including computer-based text messaging, such as e-mail or Web-based messaging from fixed computers (e.g., desktops) or mobile computers (e.g., laptops, handhelds, etc.) over wired or wireless connections, voicemail message systems, paging networks, etc.

Mobile telephones 110 and the associated short text messaging may operate according to any of a variety mobile telephone formats or protocols. As an example, some mobile telephone and short text messaging systems that formed an earlier state-of-the-art were referred to as second-generation (2G) wireless technology. Other mobile telephone and short text messaging systems that have come to form a more recent state-of-the-art have been referred to as third-generation (3G) wireless technology.

For purposes of illustration, FIG. 1 shows both a second generation (2G) mobile telephone and messaging network 114 and a third generation (3G) mobile telephone and short text messaging network 116. It will be appreciated, however, that the present invention may be employed with either 2G network 114 or 3G network 116 alone, or with a mobile telephone and short text messaging network of another format or protocol.

Second generation (2G) network 114 includes a 2G signaling network 118 that supports wireless communications with compatible mobile telephones 110 and network system communications between 2G network elements, such as a 2G mobile switching center (MSC) 120, a 2G signal transfer point 122, and an 2G home location register (HLR) 124. Third generation (3G) network 116 includes a 3G signaling network 128 that supports wireless communications with compatible mobile telephones 110 and network system communications between 3G network elements, such as a 3G mobile switching center (MSC) 130, a 3G signal transfer point 132, and a 3G home location register (HLR) 134.

2G mobile switching center (MSC) 120 and 3G mobile switching center (MSC) 130 provide network switching functions to transmit calls, messages, and other information to and from mobile telephones 110. Signal transfer points 122 and 132 provide interconnections between elements of their respective networks. As illustrated, 2G signal transfer point 122 provides interconnections between a 2G signaling network 118, a 2G short message service center for mobile-originated messages 140, sometimes referred to as a 2G message center (2GMC MO) 140, a 2G short message service center for mobile-terminated messages (2GMC MT) 142, sometimes referred to as a 2G message center (2GMC MT) 142, and a number portability database (NPDB) 144.

As illustrated, 3G signal transfer point 132 provides interconnections between a 3G signaling network 128 and a 3G short message service center for mobile-originated and mobile-terminated messages (32GMC MOMT) 150, sometimes referred to as a 3G message center (3GMC MOMT) 142. It will be appreciated that signal transfer points 122 and 132 could also provide interconnections to other network elements that are not shown.

Short message service centers 140, 142, and 150 relay, store and forward short messages between mobile telephones and external short messaging entities 112. Short message service centers 140 and 142 are separate for respective mobile-originated and mobile-terminated messages, as is characteristic of second generation networks. Short message service center 150 is illustrated as handling both mobile-originated and mobile-terminated messages, as is characteristic of third generation networks. Home location registers 124 and 134 are databases that provide storage and management of user subscriptions and service profiles that include, for example, routing information for routing a short message to an indicated subscriber, as is known in the art.

A short messaging gateway (SG) 160 provides routing for mobile-originated and mobile-terminated messages between short message service centers 140, 142, and 150 and external sources and destinations. In one implementation, SG 160 employs an industry standard SMPP (Short Message Peer To Peer) short message service protocol. The SMPP protocol is published as “Short Message Peer to Peer Protocol Specification” (version 3.4, Issue 1.2, Oct.12, 1999) (available at http://www.smpp.org/). A routing database (RDB) 162 maintains an association between a wireless NPA-Nxx range and a network, and a domain name. A directory server (DS) 164 maintains an entry for each directory number (DN) that has been ported between the 2G and 3G networks 114 and 116. Number portability database 144 is used to resolve if the DN has ported to another wireless carrier.

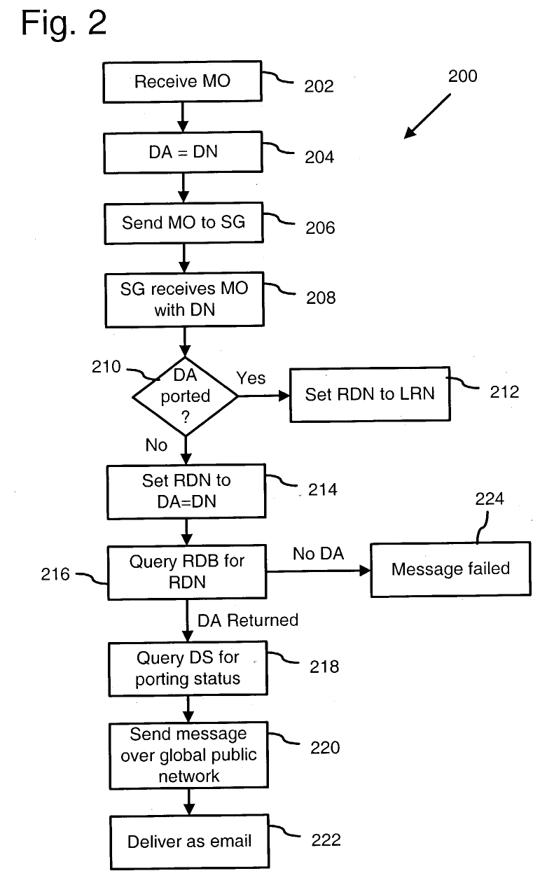

FIG. 2 is a flow diagram of a generalized implementation of an inter-carrier messaging method 200 according to the present invention. For purposes of illustration, inter-carrier messaging method 200 is directed to cellular mobile telephone messaging system 100 in which a cellular or mobile telephone carrier implementing the method has both a 2G network 114 and a 3G network 116. It will be appreciated that a cellular mobile telephone carrier may implement the methods of the present invention without both a 2G network 114 and a 3G network 116.

In step 202 a mobile-originated (MO) message is received, for example, at either the 2G short message service center (i.e., 2GMC MO 140) or the 3G short message service center (2GMC MOMT 150). The MO message includes a destination address (DA) indicating the destination to which the message is directed.

In step 204 the destination address (DA) is determined to be a directory number (DN), which typically is the ten digit “phone number” that is associated with a subscriber. For example, the determination is made by the short message service center, which makes no assumptions about the location of the subscriber or whether the DN has been “ported” to another carrier or between the 2G and 3G networks of the implementing carrier. Porting relates to a convention in which DNs that were originally associated with one carrier are transferred to another carrier. For example, a DN could be ported if a subscriber moved from a first carrier (with which the DN was originally associated) to a second carrier. Conventionally, a message could not be sent using only the DN as an address if the DN of the destination is in another carrier's network.

In step 206 the message is sent to a short messaging gateway (e.g., SG 160) for routing.

In step 208 the short messaging gateway (SG) receives the MO message with a directory number (DN) as the destination address (DA).

In step 210 an inquiry is made as to whether the destination address (DA) is ported to another carrier. For example, a short messaging gateway 160 queries a local number portability database (NPDB) 144 to resolve if the DA is ported to another carrier. Inquiry block proceeds to step 212 if the DA is ported to another carrier, and otherwise proceeds to step 214.

In step 212 the location routing number (LRN) is obtained for the ported DA, and the routing directory number (RDN) is set to the LRN. The LRN represents the home mobile switching center of the ported subscriber. For example, local number portability database (NPDB) 144 returns the LRN.

In step 214 no LRN value is returned and the routing directory number (RDN) is set to the destination address (DA).

In step 216 a routing database is queried for the routing directory number (RDN). For example, short messaging gateway 160 queries routing database 162 using the RDN. The RDB 162 maintains an association between NPA-Nxx ranges in the wireless network (both the implementing carrier and other carriers) and an associated network and domain name. The RDB query returns the network and domain associated with the destination address (DA).

For example, the routing database RDB 162 would be populated with NPA-Nxx ranges of wireless carriers that allow their subscribers to receive mobile-terminated short text messages from the Internet. The routing database (RDB) 162 could support domestic routing, international routing, or both. Table 1 lists exemplary elements in the RDB for national numbers:

TABLE 1

| | |
|---|---|
| Type of Number | National or international |
| Routing Directory | NPA-Nxx range that accepts MT short |
| Number (RDN) | messages from the Internet e-mail |
| Network | The network associated with the RDN. |
| | For example implementing carrier 2G, |
| | implementing carrier 3G, etc. |
| Domain Name | The domain name that Internet e-mail |
| | is sent to for MT short messages |
| Service type | Optional: service type SG should use |
| | to route the message. |

Table 2 lists exemplary elements in the RDB for national numbers:

TABLE 2

| | |
|---|---|
| Type of Number | International |
| Country code | Country code of number |
| Routing Directory | Number range that accepts MT short |
| Number (RDN) | messages from the Internet |
| Network | The network associated with the RDN. |
| | This could be implementing carrier 3G |
| | to deliver international short messages |
| Domain Name | The domain name that Internet e-mail |
| | is sent for MT short messages |
| Service type | Optional: service type SG should use |
| | to route the message. |

In step 218 a directory server (e.g., DS 164) is queried to determine if the subscriber has ported between 2G and 3G networks of the implementing carrier, if the routing database query of step 216 indicates that the destination address (DA) is an implementing carrier subscriber. The message is then routed to the appropriate short message service center for delivery in the wireless network.

The directory server (DS) 164 maintains information about the intra-carrier network porting status of a subscriber of the implementing carrier. An implementing carrier subscriber may port between the 2G and 3G networks while retaining a particular directory number (DN). Since routing at the routing database (RDB) 162 is done at the NPA-Nxx level, intra-carrier ported subscribers will be in the ‘wrong’ network. To resolve this situation the directory server (DS) 164 maintains an entry for each subscriber that has ported. Logically an entry in the directory server (DS) 164 would a directory number (DN) NPA-Nxx-xxxx of a ported subscriber and a Network indication that identifies the network of the implementing carrier to which the subscriber is ported.

Only subscribers that have ported between networks of the implementing carrier have an entry in the directory server (DS) 164. For example, ported subscribers are 2G subscribers that port to a 3G network and 3G subscribers that port to a 2G network. A query to the directory server (DS) 164 resulting in no number found indicates that the subscriber has not ported and that the routing information returned by the query to the routing database (RDB) 162 should be used.

A query to the directory server (DS) 164 returning a value for the network parameter indicates that the subscriber has ported and that the routing information returned by the query to the routing database (RDB) 162 should be overridden with the value returned by the DS. In alternative implementations the DS could return additional subscriber level service instructions to the short message gateway 160. One example could include inserting an alias for the ‘from’ address in MO SMS so that the originated subscriber's DN would not be revealed.

In step 220 the message is sent to the destination (e.g., mobile telephone or ESME) over a global public computer network such as the Internet, if the routing database query indicates that the destination address (DA) is in another carrier's network. For example, the message may be sent in accordance with the Simple Mail Transfer Protocol (SMTP), with a SMTP address of the form DN@domain.com. “DN” is the destination address (DA) received in the MO message, and “domain” is the domain associated with the destination address (DA) returned in the routing database query.

In one implementation, short messaging gateway 160 applies the DN@domain.com address to the short message and sends it to an e-mail hub 170 (FIG. 1) for subsequent delivery using existing SMTP procedures. The MO message arrives at e-mail hub 170 (FIG. 1) with the format used for a MO message sent to an e-mail address.

In step 222 the message is delivered to the other carrier's network as an e-mail message. The receiving carrier then delivers the message to the destination message service (MS). The destination message service (MS) can then reply. The reply is routed back using the SMTP address of the originated subscriber (DN@mobile.att.net). The reply may be delivered in the implementing carrier network using existing e-mail to MT message procedures.

In step 224 the destination address (DA) is not found in the routing database query of step 216 and the message fails. No destination address (DA) may indicate that the DA is not be a wireless directory number (DN), or the DN is in a network that does not receive SMTP messages, or the implementing carrier does not deliver messages to the network, for example.

Inter-carrier messaging method 200 has several advantages. Inter-carrier messaging method 200 can use existing SMTP delivery procedures to deliver short messages to other carriers. Messages can be delivered to subscribers who can receive messages by e-mail with an address of the form DN@domain.com. Messages can be delivered to and from networks with otherwise incompatible messaging technologies, for example GSM, CDMA, etc. Inter-carrier messaging method 200 supports porting between networks within an implementing carrier (i.e., intra-carrier porting). Also, inter-carrier messaging method 200 supports directory number portability. It will be appreciated, however, that the inter-carrier messaging of this invention could optionally be implemented without supporting porting.

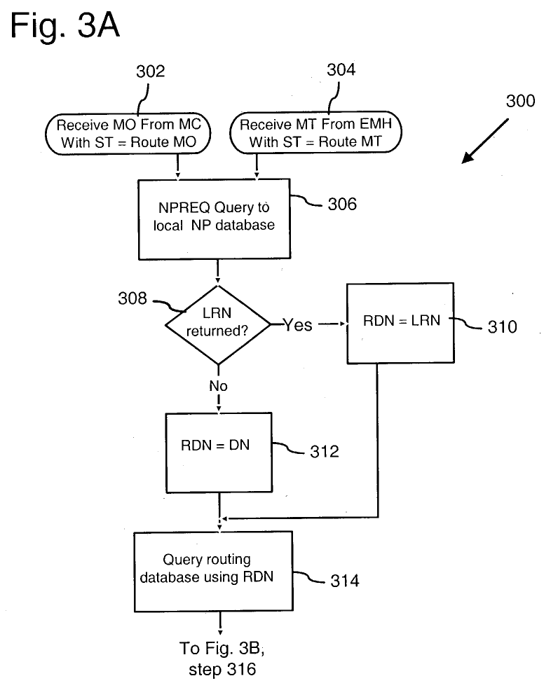

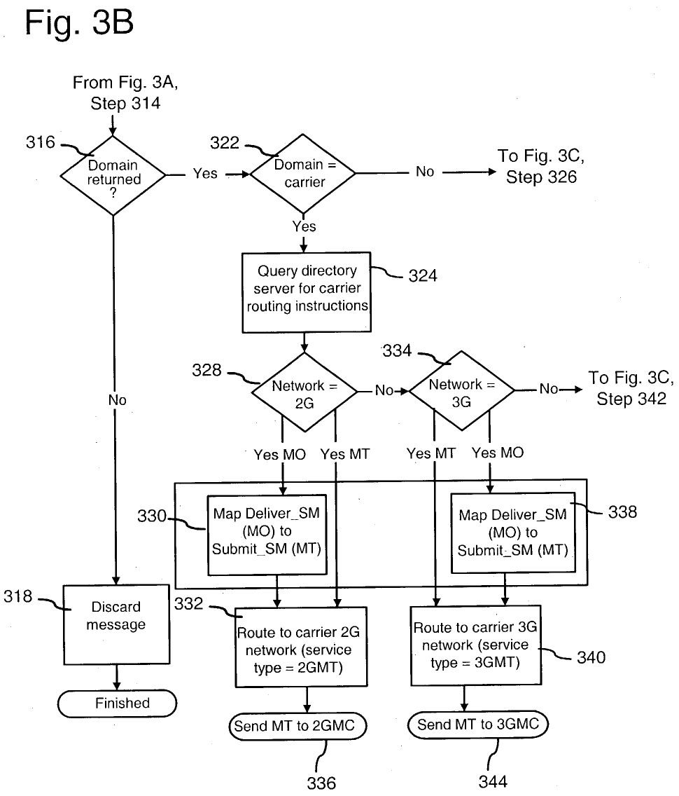

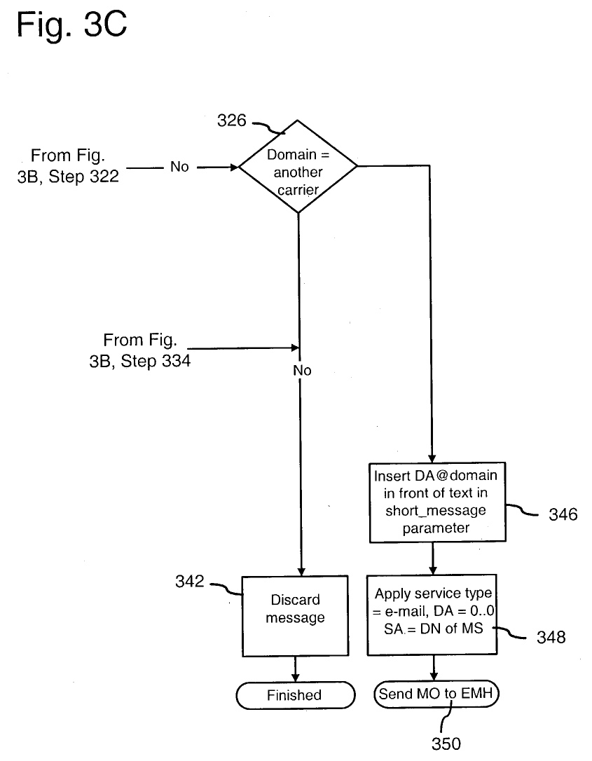

FIGS. 3A-3C are a flow diagram of a gateway routing method 300 in which, for example, shared message gateway 160 receives and routes mobile-originated (MO) and mobile-terminated (MT) messages. Gateway routing method 300 provides routing of messages based upon a determination of the porting status of the destination numbers (DN) of the messages and what network DN is in (e.g., the implementing carrier's 2G or 3G networks or another carrier's network).

In step 302, shared message gateway 160 receives a mobile-originated (MO) message from one of short message service centers 140 and 150. The mobile-originated (MO) message has a directory number (DN) as a destination address (DA).

In step 304, shared message gateway 160 receives a mobile-terminated (MT) message from the Internet 172 (FIG. 1) via e-mail hub 170 (FIG. 1). The mobile-terminated (MT) message has a directory number (DN) as a destination address (DA).

In step 306, shared message gateway 160 sends a number portability query (NPREQ) to number portability database (NPDB) 144 (FIG. 1) to determine if the directory number (DN) of the message is ported.

Step 308 is a query whether the number portability query (NPREQ) returns a location routing number (LRN).

In step 310, the number portability query (NPREQ) returns a location routing number (LRN), which indicates that the directory number (DN) of the message is ported. The LRN represents the home mobile switching center of the ported subscriber.

In step 312, the number portability query (NPREQ) does not return a location routing number (LRN), which indicates that the directory number (DN) of the message is not ported.

In step 314, shared message gateway 160 queries routing database (RDB) 162 (FIG. 1) using the routing directory number (RDN). The routing directory number (RDN) is set to the location routing number (LRN) if one is returned in the NPREQ operation, otherwise the RDN is the received directory number (DN).

Step 316 is a query whether the routing database (RDB) 162 returns a domain associated with the routing directory number (RDN). The domain indicates the network that the DN is in. The domain can indicate the implementing carrier's 2G network 114 or 3G network 116, AWS 3G network or another carrier's network (not shown).

In step 318 no domain is returned and the message is discarded.

Step 322 is a query whether the domain returned in step 316 corresponds to a network of the implementing carrier or of another carrier. Step 322 proceeds to step 324 if the domain returned in step 316 corresponds to a network of the implementing carrier, and otherwise proceeds to step 326.

In step 324 the directory server (DS) 164 (FIG. 1) is queried to resolve intra-carrier porting status for the implementing carrier.

Step 328 queries whether the result of the directory server (DS) query corresponds to the implementing carrier's 2G network. If so, step 328 proceeds to step 330 for a mobile-originated (MO) message and proceeds to step 332 for a mobile-terminated message (MT). If not, step 328 proceeds to step 334

In step 330 the MO message (Deliver_SM) is mapped to a MT message (Submit_SM)

In step 332 the message is sent to the 2G short message service center for mobile-terminated messages (2GMC MT) 142 (FIG. 1) determined by the routing database and directory server queries.

In step 336 the MT mapped message is sent to the 2G message center (2GMC MT) 142 for delivery.

Step 334 queries whether the result of the directory server (DS) query corresponds to the implementing carrier's 3G network. If so, step 334 proceeds to step 338 for a mobile-originated (MO) message and proceeds to step 340 for a mobile-terminated message (MT). If not, step 334 proceeds to step 342 where the message is discarded.

In step 338 the MO message (Deliver_SM) is mapped to a MT message (Submit_SM)

In step 340 the message is sent to the 3G short message service center for mobile-terminated messages (3GMC MTMO) 150 (FIG. 1) determined by the routing database and directory server queries.

In step 344 the MT mapped message is sent to the 2G message center (2GMC MT) 142 for delivery.

Step 326 is a query whether the domain returned in step 316 corresponds to a network of another carrier.

In step 346, the domain returned in step 316 corresponds to a network of another carrier and DN@domain is appended, with delimiters, at the beginning of the short_message parameter of the Deliver_SM PDU. (PDU refers to “protocol description unit” SMS format for sending information, as is known in the art.) “Domain” is the domain returned in the routing database query. The contents and format of the message in the short_message parameter are now identical to a MO message being sent to an e-mail address.

In step 348 the destination_addr parameter of the Deliver_SM PDU is populated with ‘0000000000’ to match current MO-to-email parameter settings and the Deliver_SM PDU is routed to the email hub 170 (FIG. 1) in step 350. The email hub 170 subsequently delivers the message using existing MO to e-mail procedures.

In step 342, the domain returned in step 316 does not correspond to a network of another carrier and the message is discarded.

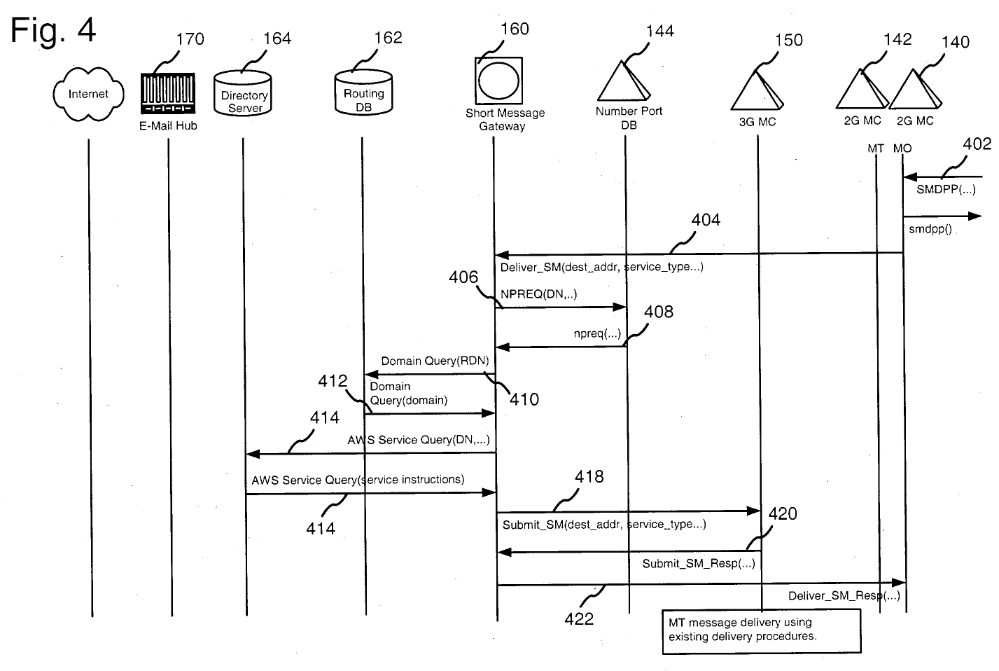

FIG. 4 is a sequential step diagram illustrating a 2G-3G delivery sequence 400 for delivering a mobile-originated message from a 2G network of an implementing carrier to a 3G network of the same carrier. Delivery sequence 400 accommodates and resolves directory numbers that are ported between networks of an implementing carrier. It will be appreciated that delivery sequence 400 could be adapted to accommodate and resolve porting of directory numbers between different combinations of networks of a carrier, including porting between a 2G and another 2G network, porting from a 3G network to a 2G network, porting between a 3G network and another 3G network, as well as porting between other types of networks.

In step 402 a 2G short message service center for mobile-originated messages (2GMC MO) 140 receives a mobile-originated (MO) message with a destination address (DA) corresponding to a directory number (DN).

In step 404 short message service center for mobile-originated messages (2GMC MO) 140 sends a Deliver_SM (deliver short message) signal to short message gateway 160 (SG).

In step 406 short message gateway 160 (SG) sends a number portability query (NPREQ) to number portability database (NPDB) 144 (FIG. 1) to determine if the directory number (DN) of the message is ported.

In step 408 number portability database (NPDB) returns a location routing number (LRN) if the directory number (DN) is ported or returns nothing if not ported.

In step 410 short message gateway 160 (SG) sends a Domain Query to routing database 162 using routing directory number (RDN). The routing directory number (RDN) is the location routing number (LRN) if one was returned in the NPREQ operation, otherwise RDN is the directory number (DN).

In step 412 routing database 162 returns domain information for the directory number (DN) indicating that the subscriber is a subscriber in the 3G network of the implementing carrier.

In step 414 short message gateway 160 (SG) sends a carrier Service Query to directory server 164 using the directory number (DN) to determine if the subscriber has ported.

In step 416 directory server 164 responds with service instructions indicating that the directory number (DN) is in the 3G network.

In step 418 short message gateway 160 (SG) maps Deliver_SM to Submit_SM and sends it to 3G short message service center for mobile-originated and mobile-terminated messages (32GMC MOMT) 150.

In step 420 3G short message service center for mobile-originated and mobile-terminated messages (32GMC MOMT) 150 responds with Sumit_SM_Resp. Message delivered in 3G network using existing procedures.

In step 422 short message gateway 160 (SG) sends Deliver_SM_Resp to short message service center for mobile-originated messages (2GMC MO) 140.

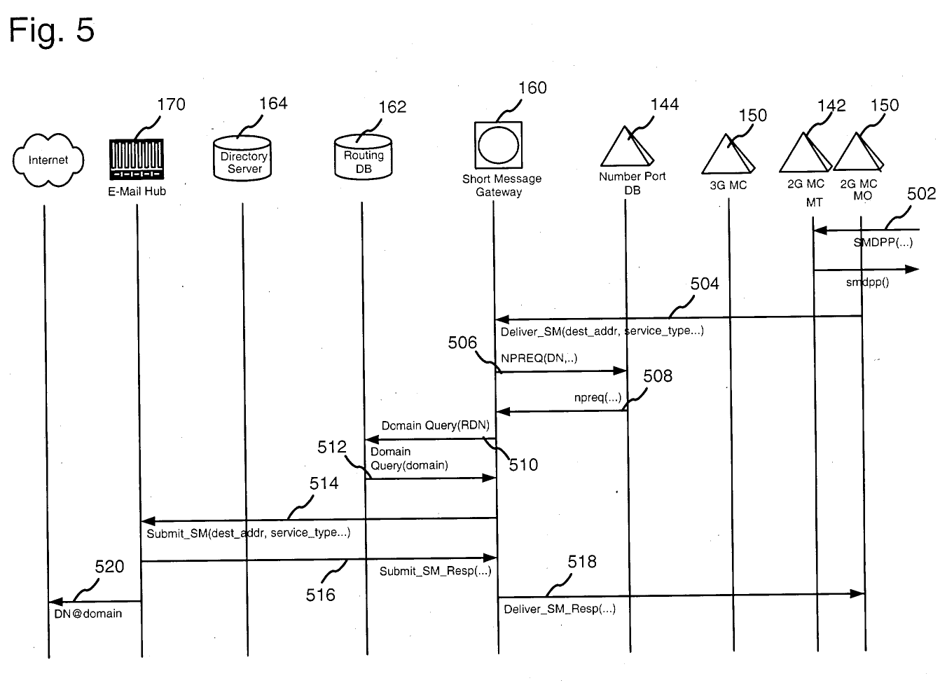

FIG. 5 is a sequential step diagram illustrating a 2G/inter-carrier delivery sequence 500 for delivering a mobile-originated message from a 2G network of an implementing carrier to another carrier. Delivery sequence 500 provides inter-carrier messaging and accommodates and resolves directory numbers that are ported.

In step 502 a 2G short message service center for mobile-originated messages (2GMC MO) 140 receives a mobile-originated (MO) message with a destination address (DA) corresponding to a directory number (DN).

In step 504 short message service center for mobile-originated messages (2GMC MO) 140 sends a Deliver_SM (deliver short message) signal to short message gateway 160 (SG).

In step 506 short message gateway 160 (SG) sends a number portability query (NPREQ) to number portability database (NPDB) 144 (FIG. 1) to determine if the directory number (DN) of the message is ported.

In step 508 number portability database (NPDB) returns a location routing number (LRN) if the directory number (DN) is ported or returns nothing if not ported.

In step 510 short message gateway 160 (SG) sends a Domain Query to routing database 162 using routing directory number (RDN). The routing directory number (RDN) is the location routing number (LRN) if one was returned in the NPREQ operation, otherwise RDN is the directory number (DN).

In step 512 routing database 162 returns domain information for the directory number (DN) indicating that the subscriber is a subscriber in the 3G network of the implementing carrier.

In step 514 short message gateway 160 (SG) sends a Deliver_SM signal to email hub 170 with DN@domain inserted in the short_message parameter.

In step 516 email hub 170 responds with a Deliver_SM_Resp signal.

In step 518 short message gateway 160 (SG) responds with a Deliver_SM_Resp signal to short message service center for mobile-originated messages (2GMC MO) 140.

In step 520 email hub 170 delivers the message using, for example, conventional SMTP deliver procedures.

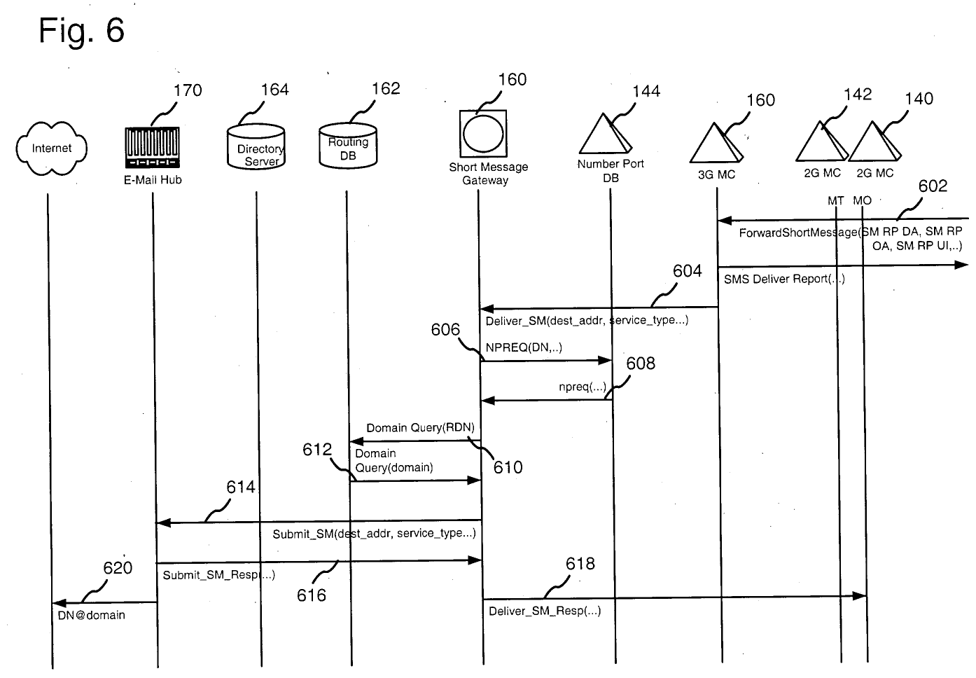

FIG. 6 is a sequential step diagram illustrating a 3G/inter-carrier delivery sequence 600 for delivering a mobile-originated message from a 3G network of an implementing carrier to another carrier. Delivery sequence 600 provides inter-carrier messaging and accommodates and resolves directory numbers that are ported.

In step 602 a 3G short message service center for mobile-originated and mobile-terminated messages (32GMC MOMT) 150 receives a mobile-originated (MO) message with a destination address (DA) corresponding to a directory number (DN).

In step 604 3G short message service center for mobile-originated and mobile-terminated messages (32GMC MOMT) 150 sends a Deliver_SM (deliver short message) signal to short message gateway 160 (SG).

In step 606 short message gateway 160 (SG) sends a number portability query (NPREQ) to number portability database (NPDB) 144 (FIG. 1) to determine if the directory number (DN) of the message is ported.

In step 608 number portability database (NPDB) returns a location routing number (LRN) if the directory number (DN) is ported or returns nothing if not ported.

In step 610 short message gateway 160 (SG) sends a Domain Query to routing database 162 using routing directory number (RDN). The routing directory number (RDN) is the location routing number (LRN) if one was returned in the NPREQ operation, otherwise RDN is the directory number (DN).

In step 612 routing database 162 returns domain information for the directory number (DN) indicating that the subscriber is a subscriber in the 3G network of the implementing carrier.

In step 614 short message gateway 160 (SG) sends a Deliver_SM signal to email hub 170 with DN@domain inserted in the short_message parameter.

In step 616 email hub 170 responds with a Deliver_SM_Resp signal.

In step 618 short message gateway 160 (SG) responds with a Deliver_SM_Resp signal to short message service center for mobile-originated messages (2GMC MO) 140.

In step 620 email hub 170 delivers the message using, for example, conventional SMTP deliver procedures.

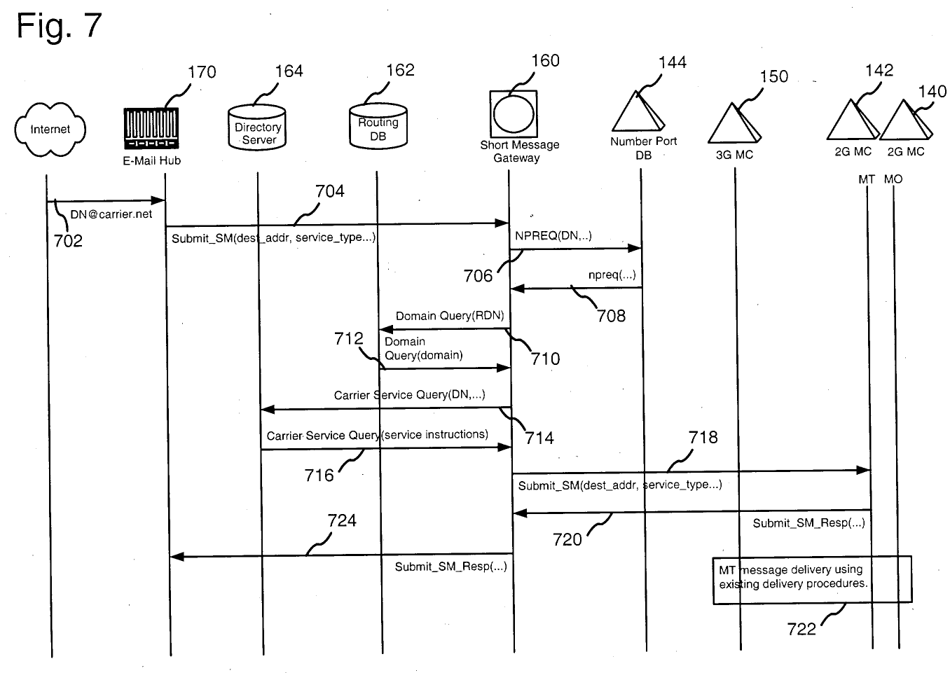

FIG. 7 is a sequential step diagram illustrating a 2G-MT delivery sequence 700 for delivering a mobile-terminated message to a 2G network. Delivery sequence 700 provides messaging to a 2G network for MT messages received at an email hub and accommodates and resolves directory numbers that are ported.

In step 702 email hub 170 receives a mobile-terminated (MT) message for DN@domain with directory number (DN) and “domain” corresponding to the domain of the implementing carrier.

In step 704 email hub 170 sends a Submit_SM (deliver short message) signal to short message gateway 160 (SG), with a destination address (DA) corresponding to the directory number (DN).

In step 706 short message gateway 160 (SG) sends a number portability query (NPREQ) to number portability database (NPDB) 144 to determine if the directory number (DN) of the message is ported.

In step 708 number portability database (NPDB) returns a location routing number (LRN) if the directory number (DN) is ported or returns nothing if not ported.

In step 710 short message gateway 160 (SG) sends a Domain Query to routing database 162 using routing directory number (RDN). The routing directory number (RDN) is the location routing number (LRN) if one was returned in the NPREQ operation, otherwise RDN is the directory number (DN).

In step 712 routing database 162 returns domain information for the directory number (DN) indicating that the subscriber is a subscriber in the 2G network of the implementing carrier.

In step 714 short message gateway 160 (SG) sends a Service Query to directory server 164 (DS) using the directory number (DN) to determine if the subscriber has ported to a 3G network of the implementing carrier.

S In step 716 directory server 164 (DS) responds with service instructions indicating that the directory number (DN) is in the 2G network of the implementing carrier. If the 2G subscriber had ported to a 3G network of the implementing carrier, the service instructions would indicate subscriber is in the 3G network.

In step 718 short message gateway 160 (SG) responds with a Submit_SM signal to short message service center for mobile-originated messages (2GMC MT) 142.

In step 720 short message service center for mobile-originated messages (2GMC MT) 142 responds with a Submit_SM_Resp signal to short message gateway 160 (SG).

In step 722 the mobile-terminated message (MT) is delivered to the 2G network.

In step 724 short message gateway 160 (SG) responds with a Deliver_SM_Resp signal to email hub 170.

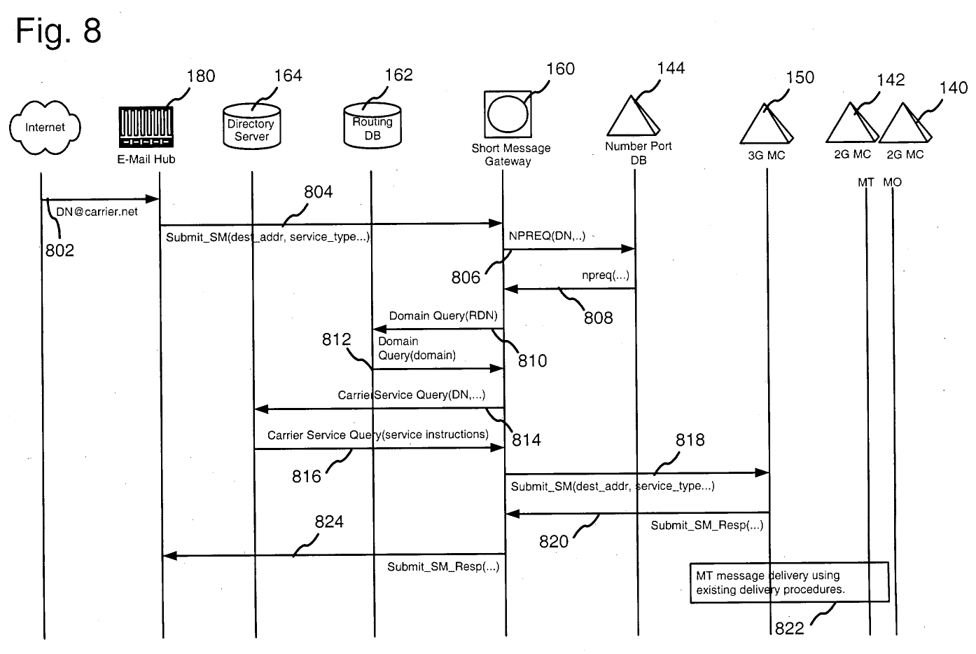

FIG. 8 is a sequential step diagram illustrating a 3G-MT delivery sequence 800 for delivering a mobile-terminated message to a 3G network. Delivery sequence 800 provides messaging to a 3G network for MT messages received at an email hub and accommodates and resolves directory numbers that are ported.

In step 802 email hub 170 receives a mobile-terminated (MT) message for DN@domain with directory number (DN) and “domain” corresponding to the domain of the implementing carrier.

In step 804 email hub 170 sends a Submit_SM (deliver short message) signal to short message gateway 160 (SG), with a destination address (DA) corresponding to the directory number (DN).

In step 806 short message gateway 160 (SG) sends a number portability query (NPREQ) to number portability database (NPDB) 144 to determine if the directory number (DN) of the message is ported.

In step 808 number portability database (NPDB) returns a location routing number (LRN) if the directory number (DN) is ported or returns nothing if not ported.

In step 810 short message gateway 160 (SG) sends a Domain Query to routing database 162 using routing directory number (RDN). The routing directory number (RDN) is the location routing number (LRN) if one was returned in the NPREQ operation, otherwise RDN is the directory number (DN).

In step 812 routing database 162 returns domain information for the directory number (DN) indicating that the subscriber is a subscriber in the 3G network of the implementing carrier.

In step 814 short message gateway 160 (SG) sends a Service Query to directory server 164 (DS) using the directory number (DN) to determine if the subscriber has ported to a 2G network of the implementing carrier.

S In step 816 directory server 164 (DS) responds with service instructions indicating that the directory number (DN) is in the 3G network of the implementing carrier. If the 3G subscriber had ported to a 2G network of the implementing carrier, the service instructions would indicate subscriber is in the 2G network.

In step 818 short message gateway 160 (SG) responds with a Submit_SM signal to 3G short message service center for mobile-originated and mobile-terminated messages (32GMC MOMT) 150.

In step 820 3G short message service center for mobile-originated and mobile-terminated messages (32GMC MOMT) 150 responds with a Submit_SM_Resp signal to short message gateway 160 (SG).

In step 822 the mobile-terminated message (MT) is delivered to the 3G network.

In step 824 short message gateway 160 (SG) responds with a Deliver_SM_Resp signal to email hub 170.

3G-MT delivery sequence 800 can accommodate general inter-carrier MT messaging. For example, a message with the address of DN@DeliveryMySMS.com,, could be routed (e.g., via SMTP) to the domain returned by the query of routing database (RDB) 162. In this way a short message could be routed to any carrier maintained in routing database (RDB) 162. This could include national and international directory numbers (DN).

In accordance with the practices of persons skilled in the art of computer programming, the present invention is described below with reference to acts and symbolic representations of operations that are performed by such computer systems, unless indicated otherwise. Such acts and operations are sometimes referred to as being computer-executed and may be associated with the operating system or the application program as appropriate. It will be appreciated that the acts and symbolically represented operations include the manipulation by the CPU of electrical signals representing data bits which causes a resulting transformation or reduction of the electrical signal representation, and the maintenance of data bits at memory locations in the memory systems to thereby reconfigure or otherwise alter operation of the computer systems, as well as other processing of signals. The memory locations where data bits are maintained are physical locations that have particular electrical, magnetic, or optical properties corresponding to the data bits.

In view of the many possible embodiments to which the principles of this invention may be applied, it should be recognized that the detailed embodiments are illustrative only and should not be taken as limiting the scope of the invention. Rather, I claim as my invention all such embodiments as may come within the scope and spirit of the following claims and equivalents thereto.

1. A method of routing a mobile telephone short text message, comprising:
receiving a short text message at a short message gateway from a first mobile telephone message network, the short text message having a destination directory number and the short message gateway and the first mobile telephone message network being operated by a first mobile telephone carrier;
determining that the destination directory number received is associated with a communication device that is in a second network that is not operated by the first mobile telephone carrier;
reformatting the short text message to include address information compatible with transmission over a global public computer network to the second network; and
sending the short text message with the address information to the second network over the global public computer network.

2. The method of claim 1 in which the short text message conforms to a Short Message Service standard.

3. The method of claim 1 in which the short message gateway is a Short Message Peer to Peer gateway that utilizes an SMPP (Short Message Peer To Peer) short message service protocol for transferring short text messages.

4. The method of claim 1 in which the address information conforms to a standard Simple Mail Transfer Protocol (SMTP).

5. The method of claim 1 further including determining whether the destination number is ported from one network to another and in which the address information accommodates the porting of the destination number.

6. The method of claim 1 in which the second network is a second mobile telephone message network that is operated by a second mobile telephone carrier different from the first mobile telephone carrier.

7. The method of claim 1 in which the short text message is mobile originated and originates from a mobile telephone.

8. The method of claim 7 in which the mobile telephone is included in the first mobile telephone message network.

9. The method of claim 1 in which the short text message is mobile terminated.

10. A method of routing a Short Message Service message, comprising:
receiving a Short Message Service (SMS) message at a Short Message Peer to Peer (SMPP) gateway from a first network operated by a first carrier, the SMS message having a destination directory number;
determining that the destination directory number received is associated with a communication device that is in a second network operated by a second carrier;
reformatting the SMS message to include a Simple Mail Transfer Protocol (SMTP) address of an SMPP gateway of the second network; and
sending the SMS message to the second network as an SMTP message over the Internet.

11. The method of claim 10 further including determining whether the destination number is ported from one network to another and in which the address information accommodates the porting of the destination number.

12. A method of routing a mobile telephone short text message, comprising:
receiving a short text message at a mobile telephone short message gateway operated by a first mobile telephone carrier, the short text message having a destination directory number;
determining whether the destination directory number is associated with a first mobile telephone network domain associated with the first mobile telephone carrier or a second mobile telephone network domain associated with a second mobile telephone carrier, the first and second mobile telephone network domains being associated with respective first and second mobile telephone message networks;
routing the short text message to the one of the first and second mobile telephone message networks corresponding to the domain with which the destination directory number is associated.

13. The method of claim 12 in which the first mobile telephone network domain has associated with it at least a first mobile telephone message network of a first mobile telephone standard format and a second mobile telephone message network of a second mobile telephone standard format, the destination directory number being associated with one of the first mobile telephone message networks of the first formats and the short text message being routed thereto.

14. The method of claim 13 in which the first mobile telephone message network of the first format is a second generation (2G) mobile telephone network.

15. The method of claim 14 in which the first mobile telephone message network of the second format is a third generation (3G) mobile telephone network.

16. The method of claim 13 in which the first mobile telephone message network of the first format is a third generation (3G) mobile telephone network.

17. The method of claim 16 in which the first mobile telephone message network of the second format is a second generation (2G) mobile telephone network.

18. The method of claim 12 in which the short text message conforms to a Short Message Service standard.

19. The method of claim 12 in which the short message gateway is a Short Message Peer to Peer gateway that utilizes an SMPP (Short Message Peer To Peer) short message service protocol for transferring short text messages.

20. The method of claim 12 in which the address information conforms to a standard Simple Mail Transfer Protocol (SMTP).

21. The method of claim 12 further including determining whether the destination number is ported from one network to another and in which the address information accommodates the porting of the destination number.
